(19) United States
(12) Patent Application Publication
(10) Pub. No.: US 2018/0054417 A1
(43) Pub. Date: Feb. 22, 2018

(54) PACKET TRACKING

(71) Applicant: lnfersight LLC, Waltham, MA (US)

(72) Inventors: Norman Schibuk, Merrick, NY (US); Boris Lukashev, Canton, MA (US); Steve Graham, Coquitlam (CA)

(21) Appl. No.: 15/678,590

(22) Filed: Aug. 16, 2017

Related U.S. Application Data
(60) Provisional application No. 62/375,948, filed on Aug. 17, 2016.

(51) Int. Cl. H04L 29/06

(52) U.S. Cl. CPC H04L 63/0245; H04L 63/145; H04L 63/1416; H04L 63/123

(57) ABSTRACT

A computer-based method includes transmitting a packet from a source across a packet-switched network that includes multiple network switches, and attaching, or otherwise associating, a unique signature to the packet at one or more of the network switches. Each unique signature identifies a corresponding one of the network switches, through which the packet passes as it travels from the source toward a destination. The packet and an attached, or otherwise associated, string of signatures from the plurality of network switches, is received at or near the destination in the packet-switched network. In a typical implementation, the validity of the packet is checked, by a validator (e.g., at or near the destination).

### CROSS-REFERENCE TO RELATED APPLICATION(S)

This application claims priority to U.S. provisional patent application Ser. No. 62/375,948, entitled Packet Tracing—Full Path Disclosure, which was filed on Aug. 17, 2016. The subject matter of the prior application is being incorporated herein by reference in its entirety.

### FIELD OF THE INVENTION

This disclosure relates to packet tracing and, more particularly, relates to packet tracing from a source to a destination in a computer-based network.

### BACKGROUND

Source path validation in packet networks may rely on a destination trusting the contents of the frames and packets received which are susceptible to modification by any entity with access to the traffic in a prior segment. As a result, digital security response personnel and systems must review traffic logs consisting of hundreds of millions records with varying levels of detail to determine actual origin and validity.

The disproportionate computational and analytical burden put on the responders provides attackers with significant advantage when attempting to evade detection.

### SUMMARY OF THE INVENTION

In one aspect, a computer-based method includes transmitting a packet from a source across a packet-switched network that includes multiple network switches, and attaching, or otherwise associating, a unique signature to the packet at one, or more of the respective network switches. Each unique signature identifies one of the network switches, through which the packet passes as it travels from the source toward a destination. The packet and an attached, or otherwise associated, string of signatures from the plurality of network switches, is received at or near the destination in the packet-switched network.

In a typical implementation, the validity of the packet is checked, by a validator (e.g., at or near the destination). Checking the validity of the packet may, in some implementations, include checking, with the computer-based validator, the string of signatures attached to, or otherwise associated with, the packet to confirm that the string of signatures match what the packet-switched network would have produced had the packet traversed the packet-switched network along a valid path from the source to the destination.

Typically, if the packet passes the validity check, the network allows the packet to be used at the destination. However, if the packet fails the validity check, the network may discard the packet or otherwise handle the packet in a manner consistent with the packet being considered, in some way, malicious or problematic.

In another aspect, a packet-switched network includes at least a first network component, a second network component, and a plurality of switches, where the first network component is coupled to the second network component via the plurality of switches. The first network component (e.g., the packet source) is configured to (and does) transmit a packet across the packet-switched network to the second network component via the plurality of switches. Each respective one of the plurality of switches may attach, or otherwise associate, a unique signature to the packet. Each unique signature identifies a corresponding one of the switches, through which the packet passes as it travels from the source toward a destination. The second network component (e.g., the packet destination) is configured to (and does) receive the packet and an attached, or otherwise associated, string of signatures from the plurality of switches, at or near the destination in the packet-switched network.

In some implementations, the packet-switched network also includes a computer-based validator at, or associated with, the destination, and the validator is configured to check the validity of the packet at or near the destination.

More particularly, in a typical implementation, the computer-based validator is further configured to check the validity of the packet at or near the destination by: checking the string of signatures attached to, or otherwise associated with, the packet to confirm that the string of signatures match what the packet-switched network would have produced had the packet traversed the packet-switched network along a valid path from the source to the destination.

Typically, if the packet passes the validity check, the validator allows the packet to be used at the destination. However, if the packet fails the validity check, the validator discards the packet or otherwise handles the packet in a manner consistent with the packet being considered, in some way, malicious or problematic.

In some implementations, one or more of the following advantages are present.

For example, a packet-switched network may be provided that blocks malicious, or otherwise harmful packets, from reaching a destination in a network. Instead, in some implementations, the suspect packet is discarded.

Moreover, a packet's path from source to destination in a network can be traced, and information representing that path can be stored. So that, if, for example, a malicious or otherwise harmful packet reaches a destination and causes harm, the source of that packet and various locations of that packet through the network can be easily identified for purposes of taking corrective measures.

The string of signatures attached to, or otherwise associated with the payload of the packet can be used to validate that the contents of the packet have not been altered between the source and destination of the network. In this regard, any layers or portions of a particular packet that have been signed can be checked to confirm that the associated packet contents have not been altered, for example, from the source and the destination.

The validators can be configured or instructed to not accept packets from a source that may have been determined to violate packet integrity (e.g., that the source is risky). In various implementations, this determination may be made by the validator disclosed herein (e.g., by a packet from the source failing validation), or by other threat, intrusion, or malware detection systems that might inform the validator that a particular source (e.g., identified by an IP address) is risky. If a packet arriving from a risky source arrives at a particular destination, the associated validator may reject that packet or otherwise handle the packet in manner consistent with the packet being considered malicious or otherwise harmful.

Other features and advantages will be apparent from the description and drawings, and from the claims.

### BRIEF DESCRIPTION OF THE DRAWINGS

FIG. 1 is a schematic representation of an exemplary computer network that includes a plurality of network components that are able to communicate with each other over a plurality of network communication links.

FIG. 2 is a flowchart of an exemplary packet tracing process that may be performed by the network in FIG. 1.

FIG. 3 is an exemplary schematic representation showing one packet traversing the network of FIG. 1 from a source to a destination, with a unique signature being attached to, or otherwise associated with, the packet, at one or more switches in the network that the packet passes through as it moves through the network.

FIG. 4 shows one such example of this kind of cross-enterprise environment that includes two distinct networks.

Like reference numerals refer to like elements.

### DETAILED DESCRIPTION

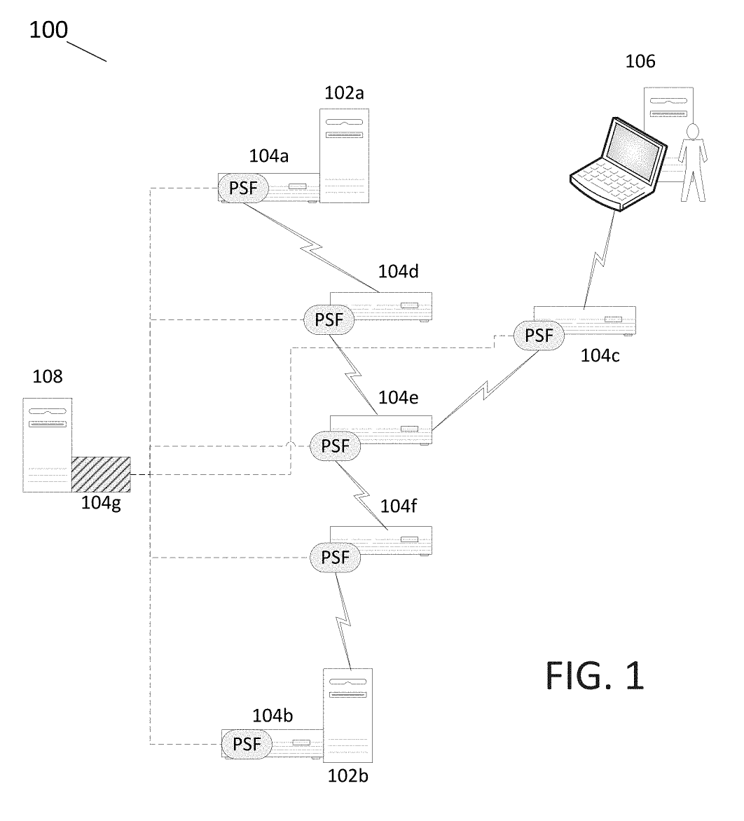

FIG. 1 is a schematic representation of an exemplary computer network 100 that includes a plurality of network components that are able to communicate with each other over a plurality of network communication links.

The components in the illustrated network 100 include a first network host 102a, a second network host 102b, a user access terminal 106, and a key manager 108. The components 102a, 102b, and 106 communicate with one another, via packet switching, over the intervening network communication links. To facilitate network communications, the first and second network hosts 102a, 102b have network interface controller (NIC) switches 104a, 104b, which are integral computer hardware components that connect the hosts into the computer network 100. The user access terminal 106 is connected to a network access switch 104c, which is a physically separate hardware component that connects the user access terminal 106 into the computer network 100. There are also three other network switches 104d, 104e, 104f that facilitate and enable communications across the network (e.g., between the first network host 102a, the second network host 102b, and/or the user access terminal 106).

During network operation, any one of components 102a, 102b, or 106 can, at any given time, act as either a packet sender (sending a packet to another component in the network 100), or a packet destination (receiving a packet from another component in the network 100). Typically, in fact, during network operations, each component may, at one point or another, send and receive many different packets.

As the packets make their way through the network 100, each switch (e.g., 104a, 104b, 104c, 104d, 104e, and/or 104f) that the packet passes through performs a packet stamping function on the packet. Every switch along the packet's path in this example is able to, and does, perform a packet-stamping function on the packet. However, this is not necessarily required. In various implementations, certain switches in a particular network may not be able to perform, or simply may not perform, a packet-stamping function on packets that pass through the switches. Indeed, in some implementations, a network may have very few—even as little as one—switch that is able to, or that does, stamp packets passing through. The packet stamping function causes a signature (e.g., a unique data string related to the identity of the switch and/or the contents of the packet) to be attached to, or otherwise associated with, the packet. In a typical implementation, the signature can be used to validate that the contents of the packet have not been altered, and can be used to identify the switch (or associated component), through which the packet passed, and that attached (or associated) the signature to the packet. If a particular packet travels through multiple switches, that packet may receive multiple different signatures.

In a typical implementation, each packet is validated at its destination. Packet validation generally refers to a process whereby a packet's one or more signatures are checked (e.g., by a validator at or associated with a packet's destination) to confirm that the signature (or string of signatures) attached to or associated with the packet matches what the network would have produced had the packet traversed the network 100 along an available and valid path. A valid path is any actual path through the network 100 from a source to a destination that does not alter contents of the packet that have been used to generate the signatures.

If a packet fails a validation attempt, that packet may be discarded or otherwise handled in a manner consistent with the notion that the packet may be, in some way, malicious or otherwise problematic.

Moreover, in a typical implementation, information about each packet's path through the network 100 may be stored and preserved (e.g., in a memory storage device) for some period of time so that if a particular packet is determined to have been in some way malicious, its path through the network can be analyzed easily to efficiently identify the source of the packet as well as any other possible locations in the network where packet corruption may have occurred.

In various implementations, one or more of the following advantages may be present. In some implementations, for example, the techniques and technologies disclosed herein may help to validate packets when they arrive at a destination in the network 100. Additionally, in some implementations, the techniques and technologies disclosed herein may help to block packets from reaching or being used at a destination if the packets are not properly validated first. Moreover, in some implementations, the techniques and technologies disclosed herein may help facilitate tracing the path of a packet through the network 100 from a source to a destination. Furthermore, in some implementations, the techniques and technologies disclosed herein may help to ensure that only packets that should reach a particular network destination actually do reach that destination. Even further, in some implementations, the techniques and technologies disclosed herein may help to ensure that any packets that are not properly validated at a destination are discarded or otherwise handled in a manner consistent with the notion that the packet may be, in some way, malicious or otherwise problematic. Moreover, in some implementations, the techniques and technologies disclosed herein may facilitate identifying the source of a packet and any other possible locations in the network that a packet passed through and, therefore, may have been corrupted after it is determined that a packet is in some way malicious. Accordingly, in a typical implementation, the techniques and technologies disclosed herein can provide significant advances in the operation of packet switched networks.

There may be many ways that the network 100 could generate the signatures that get attached to, or otherwise associated with, the packets that traverse the network 100. Likewise, there may be many possible ways that the network 100 could check the signature(s) at a packet destination. In one such example, such as the one represented in FIG. 1, the network 100 has a key manager 108 that is connected to (via NIC switch 104g) and interacts with the packet-switching functionality (PSF)-enabled switches 104a, 104b, 104c, 104d, 104e, and 104f in the network 100. More particularly, in this regard, the key manager 108 may interact with any switch in the network 100 that is charged with, or involved in, sending or forwarding a packet to a destination to create a signature for that switch to attach (or otherwise associate with) to the packet. Additionally, in this regard, the key manager 108 may interact with any switch or other component in the network charged with validating a received packet to help the switch or other component to validate the packet.

In a typical implementation, a single network (e.g., network 100) will have a single key manager 108 that interacts with all of the components (e.g., switches) in the network 100 that require such interactions.

In a typical implementation, the packet stamping and validation functionalities are performed in a manner that, at no point in time, does a single system component have all of the information available to perform and/or facilitate packet stamping and validation. This helps make the techniques and network validation disclosed herein fairly resistant to hacking.

There are several possible paths through the network 100 that a packet may travel. For each path that a packet travels through the network 100, the packet will pass through one or more network components that may be PSF enabled. Only network switches that are PSF enabled will be included in packet traces.

For example, a packet originated at the first network host 102a and intended to reach the second network host 102b may traverse the network 100 on a path that includes NIC switch 104a, network switch 104d, network switch 104e, network switch 104f, network switch 104b, and the intervening network communication links. Conversely, a packet originated at the second network host 102b and intended to reach the first network host 102a may traverse the network 100 on a path that includes NIC switch 104b, network switch 104f, network switch 104e, network switch 104d, NIC switch 104a, and the intervening network communication links.

Likewise, in the illustrated network 100, a packet originated at the first network host 102a and intended to reach the user access terminal 106 may traverse the network 100 on a path that includes NIC switch 104a, network switch 104d, network switch 104e, access switch 104c, and the intervening network communication links. Conversely, a packet originated at the user access terminal 106 and intended to reach the first network host 102a may traverse the network 100 on a path that includes access switch 104c, network switch 104e, network switch 104d, NIC switch 104a, and the intervening network communication links.

Likewise, in the illustrated network 100, a packet originated at the user access terminal 106 and intended to reach the second network host 102b may traverse the network 100 on a path that includes access switch 104c, network switch 104e, network switch 104f, NIC switch 104b, and the intervening network communication links. Conversely, a packet originated at the second network host 102b and intended to reach the user access terminal 106 may traverse the network 100 on a path that includes NIC switch 104b, network switch 104f, network switch 104e, access switch 104c, and the intervening network communication links.

Since all of these switches 104a, 104b, 104c, 104d, 104e, are 104f in the exemplary network 100 are PSF-enabled (not all switches need to be PSF-enabled), regardless of the specific path that a packet might take through the network 100 from one source to a destination, the packet will receive a signature from every one of these switches it comes in contact with (e.g., passes through).

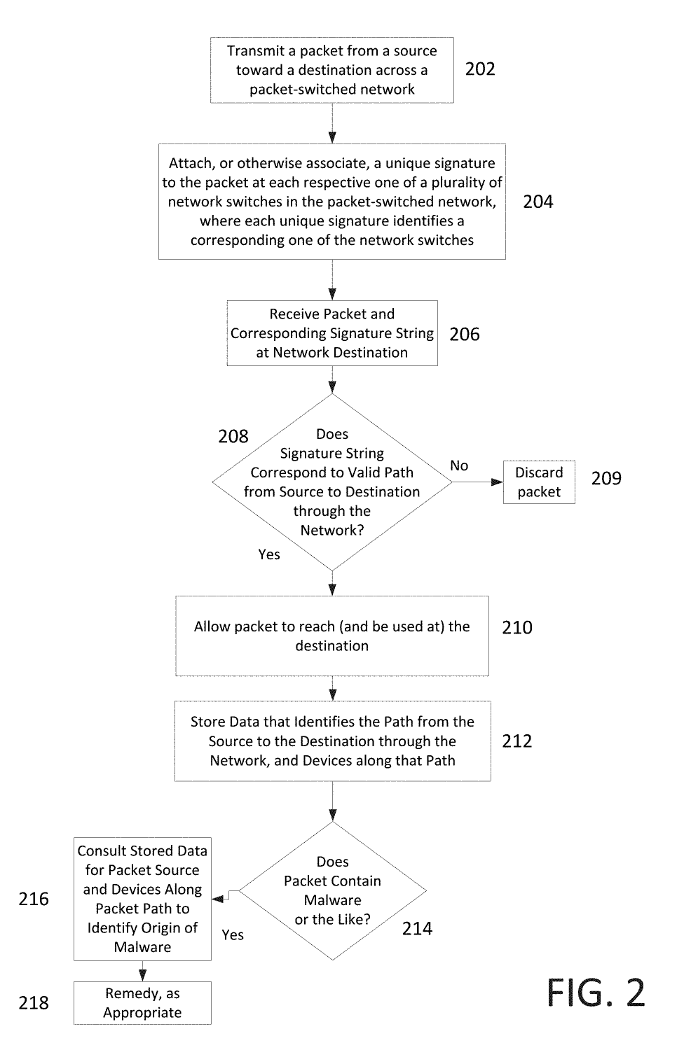

FIG. 2 is a flowchart of an exemplary process that may be performed by the network 100 in FIG. 1.

The process represented by the illustrated flowchart includes a packet source (e.g., network host 102a) transmitting a packet (at 202) across the packet-switched network 100 to a packet destination (e.g., network host 102b).

Next, according to the represented process, (at 204) each respective one of the switches in the packet-switched network 100 attaches, or otherwise associates, a unique signature to the packet, as the packet passes through that switch. Again, in some implementations, less than all of the switches along a particular packet's path may attach, or otherwise associate, a unique signature to a passing packet. Each unique signature identifies the corresponding switches, through which the packet passes as it travels from the source toward a destination, and the fact that the signature becomes attached to, or otherwise associated with, a particular switch indicates that the packet at issue has passed through the associated switch during its traversal of the packet-switched network 100 from the source to the destination. In a typical implementation, the signatures are produced at each switch in collaboration with a computer-based network key manager.

Next, according to the represented process, (at 206) the network destination (e.g., network host 102b), or a component (e.g., switch) near the network destination, receives the packet and any attached, or otherwise associated, string of signatures from any switches that the packet may have passed through during its network traversal.

Next, according to the represented process, a computer-based validator associated with the packet destination (e.g., at, near, or in communications with the packet destination) performs a validity check of the packet. According to the represented process, checking the validity of the packet includes determining (at 208), with the computer-based validator, whether the string of signatures attached to, or otherwise associated with, the packet corresponds to (e.g., matches) what the packet-switched network 100 would have produced had the packet traversed the packet-switched network 100 along a valid path from the source to the destination.

In some implementations, determining whether a string of signatures corresponds to what the packet-switched network 100 would have produced had the packet traversed the packet-switched network 100 along a valid path from the source to the destination, involves the computer-based validator accessing any materials needed to produce each of the signatures along the packet's path through the network 100, and essentially reproducing what each of the signatures should be—if the packet had traversed a valid path through the network 100. In various implementations, the computer-based validator may, in this regard, obtain the material needed to do this from the various switches involved in the packet's traversal, from the key manager, or from both.

If (at 208) the packet passes the validity check (e.g., if the computer-based validator determines that the string of signatures attached to, or otherwise associated with, the packet corresponds to (e.g., matches) what the packet-switched network 100 would have produced had the packet traversed the packet-switched network 100 along a valid path from the source to the destination), then the computer-based validator (at 210) allows the packet to reach (and be used at) the destination (e.g., at network host 102b).

If (at 208) the packet fails the validity check (e.g., if the computer-based validator determines that the string of signatures attached to, or otherwise associated with, the packet does not correspond to (e.g., does not match) what the packet-switched network 100 would have produced had the packet traversed the packet-switched network 100 along a valid path from the source to the destination), then the computer-based validator (at 209) discards the packet or otherwise handles the packet in a manner consistent with the packet being considered, in some way, malicious or problematic. In some implementations, this may include, for example, alerting a system administrator and/or one or more system users that a problem might exist in the network.

Next, according to the represented process, (at 212) the network stores, for some period of time, data that represents the packet's path through the network from the source to the destination as represented by the string of signatures associated with the packet. In some implementations, this information may include the string of signatures itself, which may be stored alone or in association with the packet itself. In some implementations, the information may be indicative of the path traversed, but not include the actual signature string itself

Next, according to the represented process, (at 214), the network (or a system administrator, for example), becomes aware (or determines), after the packet has passed the validity check and been used at the destination, that the packet was, in some way, malicious or problematic to the network 100. The system administrator (or network), at that point (216), reviews the stored data to identify the source of the packet and/or any one or more components/switches in the network 100, through which the packet may have passed when travelling across the network 100 from the source to the destination, based on the string of signatures. Clearly, access to this type of information, and the focused review that access to this type of information can enable, facilitates highly efficient identification and implementation of remedies (at 218) in the network 100—to fix any problems that may have been created by virtue of the malicious or faulty packet traversing the network 100 and/or gaining access to the network destination.

As mentioned elsewhere herein, in a typical implementation, the computer-based key manager and/or packet stamping functions may change the material used to generate and/or validate the signatures at set intervals or in response to a demand by a user. The set intervals may be set by a user.

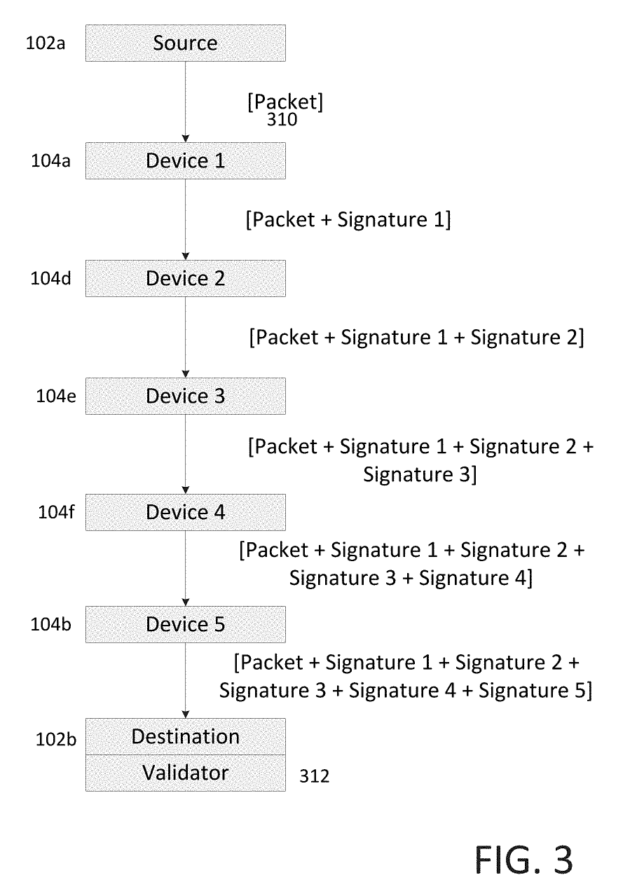

FIG. 3 is an exemplary schematic representation showing one packet 310 traversing the network 100 of FIG. 1 from a source (e.g., first network host 102a) to a destination (e.g., second network host 102b), with a unique signature optionally being attached to, or otherwise associated with, the packet, at each switch in the network 100 that the packet passes through as it moves through the network 100. Each signature uniquely identifies its associated switch. Moreover, in a typical implementation, each signature is created by the associated switch in collaboration with the key manager (e.g., 108 in FIG. 1).

According to the illustrated implementation, the packet is originated at a packet source (e.g., first network host 102a). For example, at device 1 (e.g., NIC switch 104a), signature 1, which identifies device 1, is attached to, or otherwise associated with, the packet 310. At device 2 (e.g., switch 104d), signature 2, which identifies device 2, is attached to, or otherwise associated with, the packet 310. At device 3 (e.g., switch 104e), signature 3, which identifies device 3, is attached to, or otherwise associated with, the packet 310. At device 4 (e.g., switch 104f), signature 4, which identifies device 4, is attached to, or otherwise associated with, the packet 310. Finally, at device 5 (e.g., switch 104b), signature 5, which identifies device 5, is attached to, or otherwise associated with, the packet 310.

Thus, when the packet 310 arrives at its destination (e.g., network host 102b), the string of signatures (including, e.g., signature 1, signature 2, signature 3, signature 4, and signature 5) is attached, or otherwise associated with, the packet 310. Since signature 1 corresponds to device 1 (NIC switch 104a), signature 2 corresponds to device 2 (switch 104d), signature 3 corresponds to device 3 (switch 104e), signature 4 corresponds to device 4 (switch 104f), and signature 5 corresponds to device 5 (switch 104b), this signature string identifies, at the packet destination (network host 104b), the packet's 310 precise path through the network 100—namely, that, in this example, packet 310 traveled across the network 100 through device 1 (NIC switch 104a), device 2 (switch 104d), device 3 (switch 104e), device 4 (switch 104f), and device 5 (switch 104b).

Of course, as mentioned elsewhere herein, the addition of signatures at every device is not necessarily required. In some implementations, a packet may pass through one or more switches along its path through a network without any signature being added. Generally speaking, if fewer signatures are added to a particular packet as it makes its way across a network, visibility and granularity into the packet's specific path will be lowered for packet tracing purposes.

This information about the packet's exact path through the network 100, as represented by the packet's signature string, can be used by a validator 312 at the destination (network host 102b), for example, to check that the path through the network represented by the string of signatures is a valid path through the network 100 (e.g., from the packet's supposed source to the destination). In a typical implementation, if the validity check is successful, then the packet 310 is allowed to be used at the destination (i.e., the network host 102b). However, if the validity check fails, then the packet 310 may be discarded or otherwise handled in a manner consistent with the notion that the packet may be, in some way, malicious or otherwise problematic.

The validation process typically involves determining which network devices (e.g., switches) in the system 100 correspond to each of the signatures in, or associated with, the packet 310. In this regard, in a typical implementation, the validator 312 (at the packet destination, e.g., network host 102b) collaborates with the key manager (e.g., 108 in FIG. 1) to make these determinations.

In some implementations, the network 100 may store, for some period of time, data that represents the packet's path through the network 100 from source to destination as represented by the packet's signature string. This data may include, for example, the signature string itself. This data may be stored in computer-based memory in a variety of possible ways. For example, in some implementations, the data may be stored, along with similar data associated with other packets arriving at the same destination (network host 102b) in a computer-based memory that is local to the destination (network host 102b). In some implementations, the data may be stored, along with similar data associated with other packets arriving at all destinations in the network 100 in a common computer-based memory. More particularly, in such implementations, the data that represents the packet's path through the network 100 from source to destination as represented by the packet's signature string may be mirrored to a central repository which maintains these records. This repository can be constructed in a variety of ways including a distributed store providing for a more scalable solution than a single device or location. The signatures can be verified either in real-time as the packet traverses the network or arrives at the destination, or from historical storage of the packet keys and identifiers. The signature string may also optionally be stored within the packet contents itself and stripped before the packet reaches its final destination.

If the data representing a packet's path through the network 100 as represented by the packet's signature string is stored, and that packet ends up later causing problems, because it turned out to be in some way malicious, then a system administrator, for example, can review the stored data and relatively easily determine where that packet came from and which points in the network 100 the packet contacted. This sort of information can help the system administrator a great deal to identify and remedy any network vulnerabilities that may have enabled or otherwise allowed the malicious packet to access the network 100.

Moreover, in various implementations, the key materials (i.e., one or more pieces of data) used to generate the keys, and/or the keys themselves, can be changed at set intervals (e.g., every hour, two hours) or on demand. So, if a system administrator or intelligent computer network process, for example, notices a problem (e.g., the network has been compromised or some vulnerability has allowed one or more malicious packets to access the network 100), then that administrator or intelligent network process may cause an on demand reset of one or more (or all) of the keys in the system. In response to an on demand, or scheduled change, the key manager 108 may take steps to initiate and cause the change.

What follows is a detailed explanation of parts of an exemplary process for packet signing and validation that might be performed by the network 100 in FIG. 1.

As mentioned above, when a packet arrives at its destination, the validator 312 checks the validity of that packet.

According to this exemplary process, there are two sets of parameters that the validator 312 utilizes in this regard to check packet validity. One set of parameters is pushed to the validator 312 from the key manager 108, and one set of parameters is pulled from the key manager 108 by the validator 312. In this regard, the validator requests (pulls) key set(s) from the key manager 108 to validate any signatures that the signers may have attached to, or otherwise associated with, the packet. One part of each of these key sets is a key (previous version, and current version) of the signer that signed and sent the packet. In a typical implementation, each signer always has a current version of this key and a previous version of this key. The signers rotate their keys periodically and always maintain the last computed key(s). Both keys (current version and previous version) may be added to the key set to prevent race conditions. The key is helpful to validate the identity of the signer and also may facilitate denial-or service (DOS) attack protection.

The other key in this key set is a signing key generator that may be used by both the signer and the validator to determine (e.g., compute) the signing key. More particularly, the signing key may be used by the signer to determine (e.g., compute) the signature, and the signing key may be used by the validator to determine (e.g., compute) the expected signature of the packet for validation purposes.

In some implementations, the signer sends this complete key set (identifying keys and signing keys) for some number of packets of a session (e.g., the first three packets of a TCP or UDP session) and the signer also periodically rotates the key set for long running sessions. In some implementations, header information may be added to a packet to indicate, for example, whether or not a new key set has been provided. The term session should be interpreted broadly to include, for example, any communications paths (source IP, source port, destination IP, destination port, protocol—UDP or TCP), for example, through the network 100.

The key manager 108 in this exemplary process also periodically pushes a shared key set (previous key, current key, next key) to every signer (e.g., switches 104a, 104b, 104c, 104d, 104e, and 104f in FIG. 1) and validator (e.g., 312) in the network 100. During each period of time, the key manager 108 may change the key so that a new key becomes the next key, the next key becomes the current key, and the current key becomes the previous key. In some implementations, this may help prevent race conditions that otherwise might occur with timings of when a particular device receives a key set. The shared key may be used to compute a hash for the purposes of very quick DOS checking. In a typical implementation, only the collections of signers and validators will have this information so only these devices can talk to each other. All other rogue devices will be very quickly detected so as to not allow them to access a particular device or service.

According to this exemplary process, each signer (e.g., switch 104a, 104b, 104c, 104d, 104e, and 104f in FIG. 1) attaches, or otherwise associates, a signature to each packet that passes through that signer.

In this regard, according to the exemplary process, every signer device (e.g., switches 104a, 104b, 104c, 104d, 104e, and 104f in FIG. 1) has its own signing key generator that can generate a signing key. Typically, the signing key generators are periodically rotated. Moreover, every communications session in the network 100 has a session identifier (that also may rotate, for example, during a long running session). In one exemplary implementation, the session identifier may be used along with the signer device's signing key generator to generate a current signing key for a session. Thus, in this exemplary implementation, every signer in every session will have its own unique signing key.

In this exemplary process, the signing key is hashed with the contents of one or more Open System Interconnection (OSI) layers in the packet to compute the signature. In various implementations, a signature can be associated with the immutable portions of a packet header and/or the immutable portions of any one or more of OSI layers 2 through 7—the data link layer, the network layer, the transport layer, the session layer, the presentation layer, and/or the application layer. Contents of packets using protocols not defined by the OSI model may also be signed. The way this occurs is that a signer will push its signing key generator to the key manager (e.g., 108 in FIG. 1). In a typical implementation, only the signer and the key manager 108 would be aware of this signing key generator. For every session, a network component (e.g., signer) will create a publicly visible session identifier and this session identifier may be passed through the signing key generator to create the actual signing key. In some implementations, the session identifier is passed in the key set mentioned above for the packets (one or more) that are used to represent the start of every session and may be rotated periodically in the session to effectively rotate the signing key used to compute the signature. Both the signer and key manager 108 in this example know the generator so both the signer and key manager 108 can compute the signing key. In some implementations, the key manager 108 needs to be able to do this so that it can provide the key to the validator 312 when the validator 312 requests it. The key manager 108 typically has logic in it to keep track of the validator 312 that requested a key for a given signer/session and the key manager 108 will only allow that same validator 312 to request the key again. This may be desirable, for example, to help prevent validator spoofing/cloning.

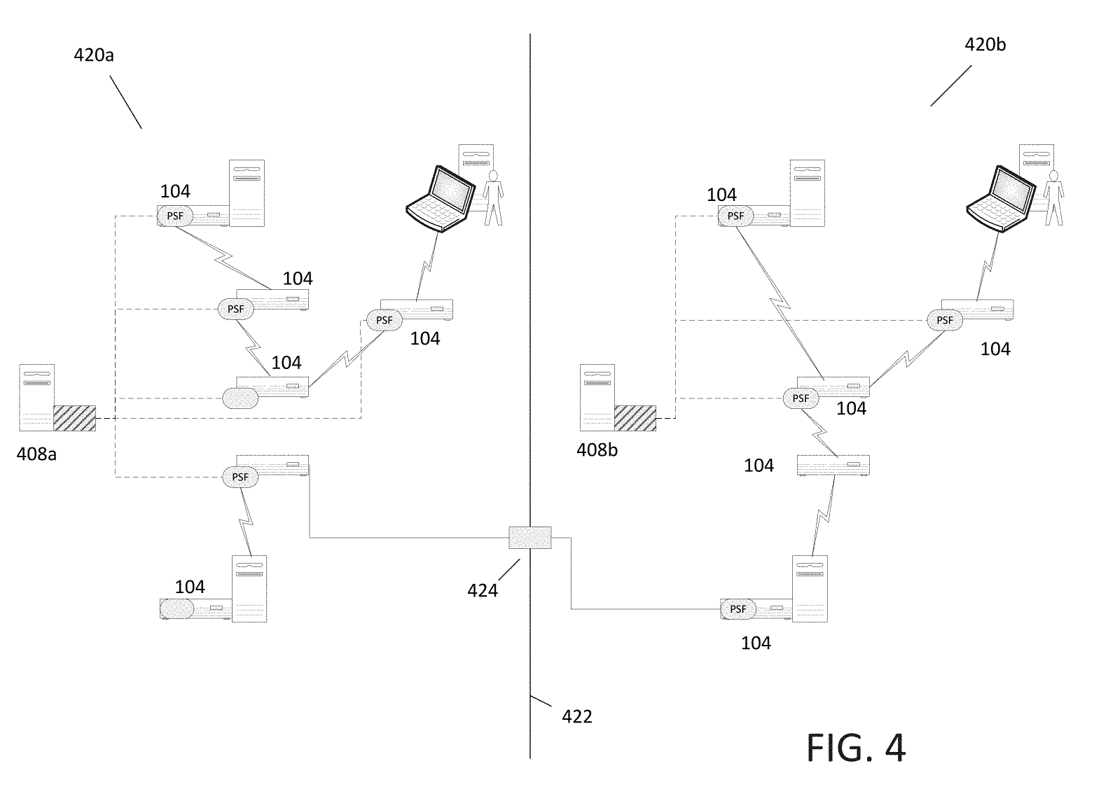

The techniques and technologies disclosed herein can be used in a cross-enterprise environment. FIG. 4 shows one such example of this kind of cross-enterprise environment that includes two distinct networks 420a, and 420b. The line 422 provided in the illustrated figure demarcates the two distinct packet-switched networks 420a, and 420b (with switches 104, some of which, but not all, are PSF-enabled). In various implementations, the two distinct networks 420a, and 420b may be separated physically and from a network security perspective, with one or more firewalls, for example, monitoring and controlling incoming and outgoing network traffic in each of the distinct networks 420a, and 420b based on predetermined security rules, and establishing barriers to various communications.

Each distinct network 420a and 420b in the illustrated implementation has a plurality of network components that are similar to the network components discussed above in connection with FIG. 1. Notably, in the illustrated implementation, each distinct network 420a, 420b has its own key manager 408a, 408b. Moreover, there is a peering connection 424 between the networks 420a, 420b that is configured to establish trust between the key managers 408a, 408b. This trust is used to allow for sharing of material. The header in a particular packet also may contain an identifier that identifies which key manager to request information from.

A number of embodiments of the invention have been described. Nevertheless, it will be understood that various modifications may be made without departing from the spirit and scope of the invention.

For example, the network 100, or networks, can include any number of network components (e.g., hosts, servers, routers, switches, etc.) arranged in any kind of way. The switches may be stand-alone components or may be associated with other components (e.g., attached to and/or configured to enable a component to communicate over a packet-switched network). In general terms, a network switch may be considered a computer networking device that connects devices together on a computer network by using packet switching, for example, to receive, process, and forward data to a destination device.

The network may include a variety of network hosts, and other network components, In general terms, a network host is a computer or other device connected to, or forming part of, a computer network. A network host may offer information resources, services, and applications to users or other nodes on the network.

A variety of other types of network components (e.g., hosts, bridges, routers, gateways, etc.) may be configured to apply signatures to a packet traversing the network.

A particular network can be configured so that a large number of network components (e.g., switches or the like) in the network attach, or otherwise associate, a signature to the passing packets, or so that only very few network components in the network attach, or otherwise associate, a signature to the passing packets. In general, adding more components that sign a packet, for example, will increase the granularity with which the network can trace a packet's path through the network.

In various implementations, the techniques and technologies disclosed herein can be applied to block and/or minimize the negative effects of malware and the like. In general, malware, short for malicious software, is an umbrella term used to refer to a variety of forms of hostile or intrusive software, including, for example, computer viruses, worms, Trojan horses, ransomware, spyware, adware, scareware, etc. It can take the form of executable code, scripts, active content, other software, etc. Malware is defined by its malicious intent, acting against the requirements of the computer user—and so generally does not include software that causes unintentional harm due to some deficiency. The techniques and technologies disclosed herein would be effective against blocking and/or minimizing unintentional harm due to deficiencies as well.

In some implementations, network and application performance can also be evaluated using the system. As part of the switch identifiers, a timestamp can be added to each identifier. Therefore, it is possible to determine the exact time that it takes a packet to traverse the network and for that packet to be processed.

In various implementations, a network may have one central validator, or many different validators. In some implementations, every destination in the network may have its own validator.

The signatures are generally digital signatures and can take any one of many different forms.

As disclosed herein, the switches, for example, attach, or otherwise associate, the signatures to the packets. A signature, therefore, can be associated with a packet in a variety of ways, even if it is not necessarily attached to the packet. In this regard, the signature from each switch may, at least theoretically, be made available (e.g., at the packet's intended destination) without necessarily having traveled with the packet. So, a destination may receive a packet and its signature(s) or signature string at separate points in time. As long as the validator has enough information in the packet and the signature(s)/string of signatures to relate the two, then the two are sufficiently associated.

In various embodiments, the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to include a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

At least some of the operations described in this specification can be implemented as operations performed by a data processing apparatus (e.g., a processor) on data stored on one or more computer-readable storage devices or received from other sources. The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings and described herein as occurring in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, some of the concepts disclosed herein may take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

Other implementations are within the scope of the claims.

What is claimed is:

1. A computer-based method comprising:
transmitting a packet from a source across a packet-switched network that comprises a plurality of network switches;
producing a unique signature at one or more of the network switches in collaboration with a network key manager;
attaching, or otherwise associating, the unique signature to the packet at each of the one or more network switches, wherein each unique signature identifies a corresponding one of the network switches, through which the packet passes as it travels from the source toward a destination;
receiving the packet and any attached, or otherwise associated, signatures from the plurality of network switches, at or near the destination in the packet-switched network.

2. The computer-based method of claim 1, further comprising checking a validity of the packet received at or near the destination.

3. The computer-based method of claim 2, wherein checking the validity of the packet comprises:
checking, with a computer-based validator, the string of signatures attached to, or otherwise associated with, the packet to confirm that the string of signatures match what the packet-switched network would have produced had the packet traversed the packet-switched network along a valid path from the source to the destination.

4. The computer-based method of claim 3, wherein, if the packet passes the validity check, allowing the packet to be used at the destination.

5. The computer-based method of claim 3, wherein, if the packet fails the validity check, discarding the packet or otherwise handling the packet in a manner consistent with the packet being considered, in some way, malicious or problematic.

6. The computer-based method of claim 1, further comprising:
storing, for some period of time, data that represents the packet's path through the network from the source to the destination as represented by the string of signatures associated with the packet. The computer-based method of claim 6, further comprising:
determining, after the packet passes a validity check at or near the destination, that the packet was, in some way, malicious or problematic to the network; and
reviewing the stored data to identify the source of the packet and/or one or more components in the network, through which the packet passed when travelling from the source to the destination.

8. The computer-based method of claim 1, further comprising:
checking a validity of the packet at or near the destination in collaboration with the network key manager.

9. The computer-based method of claim 8, further comprising:
changing, at the key manager, material used to generate and/or validate the signature at set intervals or in response to a demand by a user.

10. A packet-switched network comprising:
a first network component;
a second network component; and
a plurality of switches, wherein the first network component is coupled to the second network component via the plurality of switches;
a computer-based network key manager configured to collaborate with one or more of the switches to facilitate producing a unique signature associated with each respective one of the one or more switches,
wherein the first network component is configured to transmit a packet across the packet-switched network to the second network component via the plurality of switches,
wherein each of the one or more switches is configured to:
produce, in collaboration with the computer-based network key manager, one of the unique signatures associated with the switch; and
attach, or otherwise associate, the unique signature to the packet,
wherein each unique signature identifies a corresponding one of the switches, through which the packet passes as it travels from the source toward a destination, and
wherein the destination is configured to receive the packet and an attached, or otherwise associated, signature or string of signatures from the one or more switches, at or near the destination in the packet-switched network.

11. The packet-switched network of claim 10, further comprising a computer-based validator at, or associated with, the destination, wherein the validator is configured to check the validity of the packet at or near the destination.

12. The packet-switched network of claim 11, wherein the computer-based validator is further configured to check the validity of the packet at or near the destination by:
checking the string of signatures attached to, or otherwise associated with, the packet to confirm that the string of signatures match what the packet-switched network would have produced had the packet traversed the packet-switched network along a valid path from the source to the destination.

13. The packet-switched network of claim 12, wherein, if the packet passes the validity check, the validator allows the packet to be used at the destination.

14. The packet-switched network of claim 12, wherein, if the packet fails the validity check, the validator discards the packet or otherwise handles the packet in a manner consistent with the packet being considered, in some way, malicious or problematic.

15. The packet-switched network of claim 10, further comprising:
one or more computer-based storage devices configured to store, for some period of time, data that represents the packet's path through the network from the source to the destination as represented by the string of signatures associated with the packet.

16. The packet-switched network of claim 15, further comprising:
a user access terminal configured to enable a user to review the stored data to identify the source of the packet and/or one or more components in the network, through which the packet passed when travelling from the source to the destination.

17. The packet-switched network of claim 10, further comprising:
a computer-based packet validator at or near the destination, wherein the computer-based packet validator is configured to check the validity of the packet at or near the destination in collaboration with the computer-based network key manager.

18. The computer-based method of claim 17, wherein the computer-based key manager is configured to change key material used to generate and/or validate the signature at set intervals or in response to a demand by a user.
